(19) United States
(12) Patent Application Publication
(10) Pub. No.: US 2025/0072484 A1
(43) Pub. Date: Mar. 6, 2025

(54) BIODEGRADABLE AND COMPOSABLE FIBERS AND MATERIALS MADE THEREFROM

(71) Applicants: Oded SHOSEYOV, Shoham (IL); Eitan LAVIE, Raanana (IL); INTERNATIONAL GLOBAL CONSULTING LIMITED, Hong Kong (CN)

(72) Inventors: Oded SHOSEYOV, Shoham (IL); Eitan LAVIE, Raanana (IL)

(21) Appl. No.: 18/704,399

(22) PCT Filed: Oct. 30, 2022
(86) PCT No.: PCT/IL2022/051149

§ 371 Date: Apr. 24, 2024

Related U.S. Application Data
(60) Provisional application No. 63/263,087, filed on Oct. 27, 2021.

(51) Int. Cl. A24D 3/10; A24C 5/47; A24D 3/02; A24D 3/06; A24D 3/17; B01D 39/04; D01F 2/06

(52) U.S. Cl. CPC A24D 3/10; A24C 5/471; A24D 3/0229; A24D 3/0254; A24D 3/063; A24D 3/17; B01D 39/04; D01F 2/06; B01D 2239/025; D10B 2505/04

(57) ABSTRACT

The technology disclosed herein concerns novel fibers of regenerated cellulose and uses thereof.

### TECHNOLOGICAL FIELD

The invention generally relates to novel fibers and functional materials made therefrom.

### BACKGROUND

Regenerated cellulose fibers are fibers of cellulose, typically from a natural plant source, that have been treated and regenerated for use. Compared with synthetic fibers, regenerated cellulose is environmentally friendly, recurrent and presents no toxicity as it contains no harmful substances.

Viscose, a type of a regenerated cellulose, purposed to replace cotton, is derived from wood and other cellulose sources in a process that includes alkalization, aging, sulfuration and eventual wet spinning. Through this process, the cellulose fibers are transformed into a new type of fibers which exhibit similar tissue elements with cotton. Sustainable production and cheapness of the raw material has become a key breakthrough in textile industry. Yet, due to its limitation in production technology, its manufacturing process still causes inevitable pollution.

Modal fibers are representative of the second generation of regenerated cellulose fibers, first developed and produced in the 1980s. Modal fibers not only inherit the environmentally friendly advantage of viscose, but also maintain an ecological balance in production processes as compared with the first generation of viscose.

The short fiber represented by Tencel fibers and long fibers by Newcell are typical products of the third generation of regenerated cellulose fibers. For Tencel fibers, also known as ‘Lyocell’, needle-leave trees are used as the raw material to produce cellulose pulp, which is then mixed with a NMMO solution and heated to complete dissolution. Compared with the two earlier generations of regenerated cellulose, Tencel fibers are not only greatly improved in fabric performance such as strength, moisture absorption, stability, drapability and comfort, but also comply with modern demands of green technologies.

### General Description

Regenerated cellulose plays an important role as an industrial replacement for cotton and synthetic fibers suitable for in textile and non-woven applications. Regenerated cellulose has been used in various types of filters, ropes, abrasive materials, protective suiting material, and bandages. Specific derivatives (e.g., oxidized) have been used for pharmaceutical and medical applications, in e.g., wound dressing, tissue engineering, controllable drug delivery system, blood purification, etc. With evolving utilities, the demand for high-performance materials with tailored mechanical and physical properties has increased, leading the inventors of the technology disclosed herein to further explore production of superior regenerated cellulose fibers.

Nanocellulose (NC) materials, being cellulose nano-sized segments, also derived from cellulose, have been proven to be one of the most prominent classes of green materials of modern times. NC materials have gained growing interests owing to their attractive and excellent characteristics, which include abundance, high aspect ratios, better mechanical properties, renewability and biocompatibility. Nanocellulose materials can be categorized into cellulose nanocrystals (CNC), cellulose nanofibrils (NFC) and bacterial cellulose (BC). A number of nanocellulose forms can be produced using different methods and from various cellulosic sources. The morphology, size, and other characteristics of each nanocellulose class depend on the cellulose origin, the isolation and processing conditions as well as the possible pre- or post-treatments.

Cigarette sticks are representative of a product that has traditionally used cellulose and derivatives thereof. In a global market in which nearly 10 trillion cigarette sticks are manufactured every year, cigarette filters become a major concern to the environment. Of the filtered cigarettes 80% or more are made from cellulose acetate fibers, less than 20% of the filters are made of unique materials, and the remaining are made from polymeric materials such as polypropylene.

Cigarette sticks are typically provided with “filter tow” that is structured of crimped fibers of cellulose acetate, encased in a tipping paper. The filter tow, as further discussed hereinbelow, is structured to come into direct contact with a smoker's lips and other mouth tissues and is in fact the only physical barrier preventing tar and other particulate materials from entering the smoker's body during smoking. As the filter tows must be of a material that can perform as a barrier and as filter tows are available both in premanufactured cigarette stick forms and in forms ready for assembly into cigarette sticks, filter tows present one of the most pressing environmental concerns: environmental contamination and rather slow rate of biodegradability. Also, they present a health risk as toxins adsorbed by used cigarette filters have been found to leach into the environment, have been found to pollute the oceans and are therefore a potential biohazard.

The present technology seeks to address these problems by providing a novel biodegradable fiber, which may be used, among other uses as a cigarette filter; a fiber that is configured not only to easily degrade by, e.g., enzymes present in the environment, but more so improve, in the case of cigarette sticks, the user's experience and reduce transport of toxic materials from burnt tobacco through the filter and into the user's lungs. By using fibers of the invention in products such as cigarette tows stable, biodegradable and environmentally friendly products may be obtained.

Thus, in a first of its aspects, there is provided a material comprising regenerated cellulose chemically bound (by covalent binding) to nanocellulose, wherein the material is optionally in a form of a fiber.

Also provided is a fiber comprising regenerated cellulose chemically associated to nanocellulose, as disclosed herein.

In some embodiments, and as further disclosed herein the material is formed into or is provided as a fiber which may be a single- or a multi-filament fiber.

The chemical association between the regenerated cellulose and the nanocellulose is covalent. Some non-covalent interactions, such as hydrogen bonding and ionic interactions, may also exist. Without wishing to be bound by theory, the association is typically via formation of covalent bonds which may be selected from ester bonds, amide bonds and others. Thus, the term “association” or “chemical association”, or any equivalent term, when made in reference to the bonding between the regenerated cellulose and the nanocellulose to yield a product material of the two, is covalent bonding, typically via ester or amide groups. In some cases, the association between the two materials proceeds via a bridging molecule or a chemical linker which may be a dicarboxylic acid, or a polycarboxylic acid material (having 3 or more carboxylic acid groups), such as 1,2,3,4-butane tetracarboxylic acid, citric acid and others. The linker is selected to associate to functionalities on the regenerated cellulose and the nanocellulose, crosslinking the two materials. As each of the cellulose materials comprises hydroxyl groups and potentially other active functionalities, association with a dicarboxylic acid or a polycarboxylic acid may generally yield ester bonds between the materials, as well as internal chemical associations between groups on each of the individual materials. In other words, association between the two materials provides intra- and inter-molecular crosslinking.

Thus, in some embodiments, the regenerated cellulose is covalently bonded to the nanocellulose through a linker. The linker is selected to form ester bonds with the regenerated cellulose and the nanocellulose.

In some embodiments, the regenerated cellulose and the nanocellulose are crosslinked via covalent bonds formed (or present) between functionalities, e.g., being or comprising OH functionalities, present on each of the regenerated cellulose and the nanocellulose.

In some embodiments, the linker may be derived from a dicarboxylic acid or a polycarboxylic acid, i.e., thereby to form ester (or amide) bonds with hydroxy (or amine) functionalities which may be present.

In some embodiments, the linker is selected to be of an efficient length and size so as to enable packed arrangement of the fibers following crosslinking. Thus, in some embodiments, the linker comprises two or more carboxylic (—COO—, —COOH) groups, such that each carboxylic group is separated from another by a few carbon groups (C, CH, CH₂ groups) or heteroatoms (O, N or S). The number of carbon or heteroatoms atoms separating between each carboxylic acid group is between 1 and 5.

In some embodiments, the linker comprises between 3 and 10 carbon atoms.

In some embodiments, the linker is an aliphatic material comprising 2 or 3 or 4 or 5 carboxylic acid groups.

In some embodiments, the carboxylic groups are used in crosslinking the regenerated cellulose to the nanocellulose and optionally further crosslinking different regenerated cellulose molecules to each other and crosslinking different molecules of the nanocellulose to each other.

For the sake of brevity, the regenerated cellulose chemically modified with nanocellulose according to the invention is herein referred to in short as a nanocellulose modified regenerated cellulose or NCMRC.

As used herein, the term “fiber” refers to a single- or a multi-filament of regenerated cellulose that may be of various lengths and which is chemically associated with nanocellulose as disclosed herein. As known in the art, “regenerated cellulose” is a material typically produced by converting naturally produced cellulose to a soluble cellulosic derivative that is subsequently regenerated. The fibers of the regenerated cellulose may be of a length extending between 0.5 cm and thousands of meters and ranging in thickness between 0.5 micron and 500 microns. When processed into a final product, or for the purpose of treating same in accordance with the invention, the fiber may be cut to any processable length.

In some embodiments, the regenerated cellulose is derived from cellulose, e.g., wood cellulose, that is dissolved, purified, and extruded to produce the regenerated cellulose.

An example of a process for manufacturing regenerated cellulose is provided in, e.g., ACS Sustainable Chem. Eng. 2021, 9, 13, 4744-4754.

The association between the regenerated cellulose and the nanocellulose in the NCMRC is typically covalent, while ionic and/or hydrogen interactions may also occur. Notwithstanding the association, the regenerated cellulose becomes coated with one or more layers or coats or shells of the nanocellulose. After initial association between the regenerated cellulose and the nanocellulose, further coatings may be formed by association of a new amount of a nanocellulose to the nanocellulose already on the surface of the regenerated cellulose. Regenerated cellulose fibers assembled in bundles may also be linked together through crosslinked nanocellulose bridges.

When in a fiber form, fibers may be prepared by a variety of technologies. According to a non-limiting process, a regenerated cellulose fiber may be coated reel-to-reel with a nanocellulose material. Any method of application of the nanocellulose may be utilized, including spraying, dipping, brushing, contact transfer and others. As the nanocellulose material comprises primary reactive sites (such as hydroxyl groups), they possess a high surface area-to-volume ratio, making the nanocellulose highly reactive and easy to be functionalized. Cellulose nanocrystals (CNC), as an example of such a nanocellulose material, are capable to chemically impart stable positive or negative electrostatic charges on their surfaces for a better distribution of particles and to enhance their compatibility. The initial association via non-covalent bonding is achieved by passing the fibers and the nanocellulose via a hot air chamber. Multilayers with different actives may be applied on the fibers.

To achieve proper association via covalent bonding and coating of the regenerated cellulose fibers, compositions which include nanocellulose and a di- or a polycarboxylic acid may be used. An example of a polycarboxylic acid may be 1,2,3,4-butane tetracarboxylic acid (BTCA) or citric acid. Any other suitable carboxylic acid such as tartaric acid for example capable of generating ester bonds to crosslink the nanocellulose to the regenerated cellulose or the nanocellulose to itself may be used. Catalysts such as and sodium hypophosphite (SHP) or other acids such as mineral acids and organic acids may also be used.

The “nanocellulose” used is any nanomaterial derived from cellulose. The nanomaterial may be provided in a variety of forms, such include for example cellulose nanocrystals (CNC), nanofibrilar cellulose (NFC), bacterial nanocellulose (BC) and combinations thereof.

In some embodiments, the nanocellulose is thus selected from CNC, NFC, BC and combinations thereof. In some embodiments, the nanocellulose is CNC.

In some embodiments, a material or a fiber of the invention comprises or is formed of regenerated cellulose covalently associated with CNC.

CNC, also known as nanocrystalline cellulose (NCC) and cellulose nanowhiskers, is a fiber produced from cellulose, wherein the CNC is typically a high-purity single crystal. CNC fibers constitute a generic class of materials having mechanical strengths equivalent to the binding forces of adjacent atoms. The resultant highly ordered structure produces not only unusually high strengths but also significant changes in thermal, electrical, optical, magnetic, and other properties. The tensile strength properties of CNC are far above those of the current high volume content reinforcements and allow the processing of the highest attainable composite strengths.

CNC may be produced from cellulose or any cellulose containing material or from fibrillated cellulose by means known in the art. The CNC may be the material having CAS number 9004-34-6 or its sulphated form having CAS number 9005-22-5.

In some embodiments, the CNC is prepared according to procedures provided, for example, in WO 2012/014213, WO 2015/114630, and in US applications derived therefrom, each being herein incorporated by reference.

As known in the art, cellulose nanofibrils (CNF or NFC) are cellulosic materials composed of at least one primary fibril, containing crystalline and amorphous regions, with aspect ratios usually greater than 50. Their length is 0.1-5 μm and their diameter is below 100 nm or e.g., between 5 and 100 nm or between 5 and 60 nm.

In some embodiments, the cellulose nanomaterial is characterized by having at least 50 percent crystallinity. In some embodiments, the cellulose nanomaterial is monocrystalline. In some embodiments, the cellulose nanomaterial is high purity monocrystalline material.

In some embodiments, the nanomaterial has a length of at least about 50 nm. In other embodiments, the length is at least about 100 nm or at most 1,000 nm. In other embodiments, the length is between about 100 nm and 1,000 nm, 100 nm and 900 nm, 100 nm and 600 nm, or between 100 nm and 500 nm.

In some embodiments, the length is between about 10 nm and 100 nm, 100 nm and 1,000 nm, 100 nm and 900 nm, 100 nm and 800 nm, 100 nm and 600 nm, 100 nm and 500 nm, 100 nm and 400 nm, 100 nm and 300 nm, or between about 100 nm and 200 nm.

The nanocrystals may be selected to have an averaged aspect ratio (length-to-diameter ratio) of 10 or more. In some embodiments, the averaged aspect ratio is between 10 and 100, or between 20 and 100, or between 30 and 100, or between 40 and 100, or between 50 and 100, or between 60 and 100, or between 70 and 100, or between 80 and 100, or between 90 and 100, or between 61 and 100, or between 62 and 100, or between 63 and 100, or between 64 and 100, or between 65 and 100, or between 66 and 100, or between 67 and 100, or between 68 and 100, or between 69 and 100.

The NCMRC of the invention is typically formed into fibers which can be utilized in a variety of applications and can be used for producing a variety of products. Thus, the invention further provides a product, an object or an article comprising a NCMRC according to the invention.

Fibers of the invention may be provided as bundles of fibers which may comprise one or more fibers or at least one fiber of the invention.

In some embodiments, the number of fibers in each bundle may vary, wherein at least 10, 20, 30, 40, 50, 60, 70, 80, 90 or 100% of the fibers in the bundle are fibers according to the present invention.

In some embodiments, a bundle of fibers may comprise one or more fibers that are different from fibers of the invention or different from fibers of regenerated cellulose, provided that the bundle comprises one or more fibers of the invention. In some embodiments, the fibers that are different from fibers of the invention may include cellulose acetate.

In some embodiments, a fiber of the invention is formed into a product that is a filter. The filter may be in a form of a bundle or a plurality of fibers, e.g., arranged to produce a filtering element or device.

In some embodiments, the filter may be a filtering device or a membrane capable of or configured for isolating or entrapping or avoiding transfer of particulate materials from one end to the other. In some embodiments, the product is a filter used in smoking articles, e.g., a cigarette stick.

Thus, in another aspect, there is provided a NCMRC fiber for use in manufacturing a cigarette filter tow.

The invention additionally provides a cigarette filter tow structured of a plurality or a bundle of fibers, said plurality or bundle of fibers comprising at least one fiber of NCMRC.

A filter tow is filter structured as a rod segment positioned or configured or structured to be position at an end of a cigarette or an electronic smoking device and which purpose is to remove tar and nicotine from entering a smoker's body, while maintaining favorable taste and feel to the smoker.

Filter tows of the invention have demonstrated superior hardness and effectivity in filtering out or withholding tar and nicotine particles from passing therethrough and entering a smoker's body. To increase a smoker's experience, the filter tow comprising a plurality of NCMRC fibers may also comprise flavoring agents or generally any one or more additives. The additives are typically not chemically associated with any one fiber in a bundle of fibers making up the tow. However, in some implementations, fibers used according to the invention may be further modified to associate to one or more functional materials. Whether chemically or physically associated with a fiber or added to a collection of fibers comprising or consisting or constructed of NCMRC, the additive or functional material may be selected amongst plasticizers; chelating materials; adsorbing materials such as carbon black and charcoal; carbonaceous materials; flavoring materials; sweeteners; coloring materials or pigments; fragrant materials; flame retardants such as sodium tugstanate; taggant materials; ionic materials; reinforcing materials; pH stabilizers or modifiers; desiccants; antioxidants; solidifiers, UV stabilizers, polymeric materials, and any other material selected to endow the fiber or a collection of fibers with one or more additional attribute.

In some cases, the additive or functional material is contained within the bundle or collection of fibers or between layers of the nanocellulose, e.g., CNC, formed on the surface of the regenerated cellulose fiber. In some other cases, at least a portion of the additives or functional material may be chemically associated with the CNC or the regenerated cellulose. Thus, the invention also provides a regenerated cellulose fiber that is chemically associated to both nanocellulose, as defined, and to a functional material selected as above, for use in the manufacture of a cigarette tow.

The invention also provides a filter tow (a cigarette filter) that is configured for the conventional and electronic cigarettes. Use of NCMRC wherein the nanocellulose is, e.g., CNC, in the presence or absence of any one or more additives or functional materials, as defined herein contributes to the Young modulus of the fiber (stiffness), reduces surface roughness of the filter, thereby leading to a better control of porosity in achieving desirable tar/nicotine retention and pressure drop values. Due to the ester bond formed between the regenerated cellulose and the nanocellulose, the filter is readily biodegradable or compostable, having increased sensitivity towards hydrolysis by naturally occurring esterase enzymes and cellulases present in the environment, e.g., soil, and thus, provides a viable alternative to filters manufactured of fine cellulose acetate.

In conventional cigarettes, the filter is wrapped in a plug wrap. The filter may be joined via a tipping paper to a tobacco tow consisting of a loose tobacco mixture and wrapped in a cigarette paper. In electronic cigarettes, the inhaler (also known as ‘cartridge’, a disposable non-refillable plastic mouthpiece) contains an absorbent material that is saturated with a liquid solution containing nicotine. In many cases, the absorbent material can comprise woven fibers or a sponge-like material according to the invention, per se, or with additional general and/or selective absorbent material as above. The absorbent material may be shaped as a hollow cylinder disposed adjacent to an exterior of a tube encircling the same, and may be in fluid communication with a vaporizing device.

Filter tows of the invention may be provided separately or part of a complete cigarette.

Thus, the invention provides a cigarette having a filter tow formed of or comprising NCMRC according to the invention.

Also provided is a kit or a commercial product containing a plurality of cigarette tows according to the invention, rolling papers and tobacco, and optionally further instructions to roll a cigarette.

Also provided is an electronic cigarette adapted to receive a filter tow according to the invention.

Fiber tows according to the invention may be manufactured as known in the art. For example, conventional filter cigarettes are produced by joining tobacco rods with filter tows and connecting them with a tipping paper, followed by cutting operations. The filter rods are typically made by wrapping cellulose acetate tow into a fiber rod with a wrapping paper and cutting the resulting wrapped filter rod into pieces. Typically, triacetin is used as a plasticizer for cellulose acetate filters. The fiber materials of the invention may be similarly used for manufacturing the filter tows. Thus, CNC and a crosslinker (provided optionally in a formulation form) maybe used to assemble regenerated cellulose filter in essentially same cigarette filter machines used in the industry.

Thus, in another aspect there is provided a method for producing a filter tow for a smoking article, e.g., a cigarette stick, the method comprising arranging a plurality of fibers according to the invention into a rod structure with a first rod end a second filter rod end and a circumferential rod surface, wrapping the outer surface of the rod structure covering at least a part or a complete circumference of the rod surface; and optionally cutting the wrapped rod perpendicular to the rod longitudinal direction into rod segments, each segment being a filter tow suitable for the smoking article.

The invention further provides method of manufacturing a smoking article, e.g., a cigarette, the method comprising joining a tobacco rod (or a rod of any other smoking material) with a filter tow and connecting them with a tipping paper, and optionally cutting or shaping said joined tobacco rod and filter tow to provide the smoking article.

The invention provides:

A material comprising regenerated cellulose covalently bonded to nanocellulose, wherein the material is optionally in a form of a fiber.

A material of the invention may be in a form of a fiber.

A material of the invention may be in a form of a single- or multi-filament fiber.

A material of the invention may be formed of the regenerated cellulose that is covalently bonded to the nanocellulose through a linker.

A material of the invention may be formed with the linker, such that it forms ester bonds with the regenerated cellulose and the nanocellulose.

A material of the invention may be such that the regenerated cellulose and the nanocellulose are crosslinked comprising covalent bonds between the regenerated cellulose and the nanocellulose.

A material of the invention may be such that the linker is derived from a dicarboxylic acid or a polycarboxylic acid.

A material of the invention may be such that the dicarboxylic acid or polycarboxylic acid form ester bonds with hydroxyl groups present on the regenerated cellulose and the nanocellulose.

A material of the invention may be such that the nanocellulose is a nanomaterial derived from segmented cellulose.

A material of the invention may be a nanocellulose that is selected from cellulose nanocrystals (CNC), nanofibrilar cellulose (NFC) and bacterial cellulose (BC).

A material of the invention may be based on CNC.

A material of the invention may comprise regenerated cellulose covalently bonded to a CNC, wherein the material is optionally in a form of a fiber.

A material of the invention may be such that the CNC forms covalent layers or coats on a fiber of the regenerated cellulose.

A fiber composed of a material comprising or consisting regenerated cellulose covalently bonded to nanocellulose.

A fiber of the invention may be formed of a material that is a material according to the invention.

A fiber of the invention may be such that the regenerated cellulose is provided as a fiber covalently associated with the nanocellulose.

A fiber of the invention may be such that the regenerated cellulose fiber is associated with one or more coats or layers of the nanocellulose.

A fiber of the invention may be a single or a multi-filament fiber.

A fiber of the invention may be for use in the manufacture of a filter.

A fiber of the invention may be used in a filter that may be a filtering device or a membrane capable of isolating or entrapping or arresting transfer of particulate materials from one end of the filter to the other.

A fiber of the invention may be such that the filter is for use in a smoking article.

A fiber of the invention may be such that the filter is a cigarette tow.

A fiber of the invention may be such that the nanocellulose is selected from cellulose nanocrystals (CNC), nanofibrilar cellulose (NFC) and bacterial cellulose (BC).

A fiber of the invention may be based on CNC.

A fiber formed of a regenerated cellulose covalently bonded to a CNC.

A fiber of the invention may comprise one or more additives selected amongst plasticizers; chelating materials; adsorbing materials; carbonaceous materials; flavoring materials; sweeteners; coloring materials or pigments; fragrant materials; flame retardants; taggant materials; ionic materials; reinforcing materials; pH stabilizers or modifiers; desiccants; antioxidants; solidifiers; UV stabilizers; and polymeric materials.

A bundle of fibers comprising at least one fiber according to the invention.

A bundle of fibers of the invention may be a bundle consisting fibers according to the invention.

A bundle of fibers of the invention may be in a form of a cigarette tow.

Use of a material according to the invention for manufacturing a cigarette tow.

Use of a fiber according to the invention for manufacturing a cigarette tow.

A cigarette tow comprising or consisting a fiber according to the invention or a fiber comprising or consisting a material according to the invention.

A cigarette tow according to the invention may be provided wrapped in a plug wrap.

A cigarette tow according to the invention may be in a form joined via a tipping paper to a tobacco tow wrapped in a cigarette paper.

A cigarette tow according to the invention may be for use in a cigarette or an electronic cigarette.

A cigarette tow comprising a plurality of fibers composed of regenerated cellulose covalently associated with CNC.

A cigarette provided with a filter tow according to the invention.

A kit or a commercial product containing a plurality of cigarette tows according to the invention, rolling papers and tobacco, and optionally further instructions to roll a cigarette.

An electronic cigarette adapted to receive a filter tow according to the invention.

A method for producing a filter tow for a smoking article, the method comprising arranging a plurality of fibers according to the invention into a rod structure with a first rod end, second filter rod end and a circumferential rod surface, wrapping the outer surface of the rod structure covering at least a part or a complete circumference of the rod surface; and optionally cutting the wrapped rod perpendicular to the rod longitudinal direction into rod segments, each segment being a filter tow suitable for the smoking article.

A method of manufacturing a smoking article, the method comprising joining a tobacco rod or a rod of a smoking material with a filter tow according to the invention and connecting them with a tipping paper, and optionally cutting or shaping said joined tobacco rod and filter tow to provide the smoking article.

A method according to the invention may comprise providing a fiber of regenerated cellulose covalently associated to nanocellulose.

A method according to the invention may comprise providing a fiber of regenerated cellulose covalently associated to nanocellulose and forming arranging a plurality of such fibers into a filter tow.

A method according to the invention may be such that the filter tow comprises fibers different from regenerated cellulose.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides an illustration of fiber bundle preparation on coupon for standardized tensile testing.

FIG. 2 provides tensile testing of fiber bundles (20 mg per bundle).

FIG. 3 provides a summary of cut test on fiber bundles (images are shown in FIG. 4).

FIG. 4 provides images after cut testing of different bundles cut with different forces.

### DETAILED DESCRIPTION OF EMBODIMENTS

### Materials

The viscose tested was supplied as free samples from Lenzing, Austria; CNC (Cellulose Nano Crystals) were supplied from Melodea, Israel; BTCA (1,2,3,4-Butanetetracarboxylic acid) and SHP (Sodium Hypophosphate) were purchased from Sigma-Aldrich.

### Solution Preparation

A solution of 2 wt. % CNC in water was prepared by diluting the obtained 3 wt. % solution from Melodea, Israel with DW (distilled water). 3 mg/ml of BTCA and 0.1 mg/ml SHP were added as dry salts to the 2 wt. % CNC. The solution was mixed in a ultrasonicator (QSonica 500) for 10 min on a 1 sec on, 1 sec off regime at 25% amplitude in a 50 ml falcon tube. The solution was place in a travel spray bottle purchased in a local pharmacy (SuperPharm, Israel). Each spray weighed on average 123±7 mg.

### Viscose Fiber Preparation

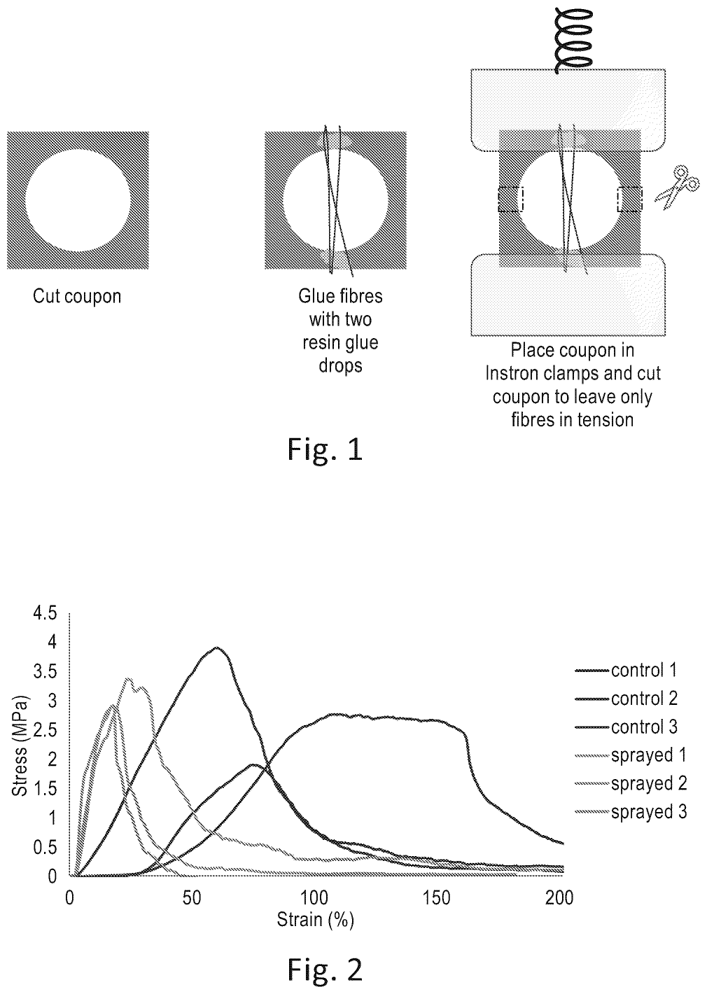

Viscose fibers were supplied by Lenzing as staple fibers of 1.7 dtex and 40 mm staple length. An adaptation of ASTM D3822-07 was used to design the fiber testing apparatus, as shown in FIG. 1. Carboard coupons were cut into squares of 25 mm sides and a circle of 15 mm diameter was cut out in its center. Fibers were glued to two sides of the coupon in tension using a drop of two part express epoxy glue. Coupons were help suspended and two sprays of the CNC (+BTCA+SHP) were performed on each side of the fibers. Coupons were left to dry for one hour in an oven kept at 80° C.

Coupons are then cut on the two sides perpendicular to the fibers allowing position between clamps and testing on fibers only. As illustrated below. To ensure consistency as well as to define a scalable and reasonable quantity, bundles of 20 mg were weighed and aligned on each coupon.

### Tensile Testing Results

TABLE 1
strength comparison of viscose fiber bundles

| | CONTROL | SPRAYED |
|---|---|---|
| Ultimate tensile stress (Mpa) | 2.85 ± 0.99 | 3.06 ± 0.26 |
| Young's modulus (Mpa) | 19 ± 5 | 103 ± 51 |

The tensile test performed yields several conclusions. As shown in FIG. 2, overall, the sprayed bundles of fiber (20 mg for each sampling) are more consistent in terms of elongation before break and ultimate strength. While the untreated bundled are seem more extendable, they are on average 5 times weaker (with respect to Young's modulus) than the sprayed fibers going up to 10 times for the best performing samples. This can be explained by the crosslinking effect that coalesce the CNC to the viscose fibers and the fibers together leading to a much more compact and tidier bundle. The higher elongation can be caused by slippage as an artefact of having free-moving bundled fibers. While one sample of untreated displays higher UTS, the average UTS is higher for treated. Overall, the sprayed formulation improves the strength of the fiber bundles.

### Viscose Cut Test

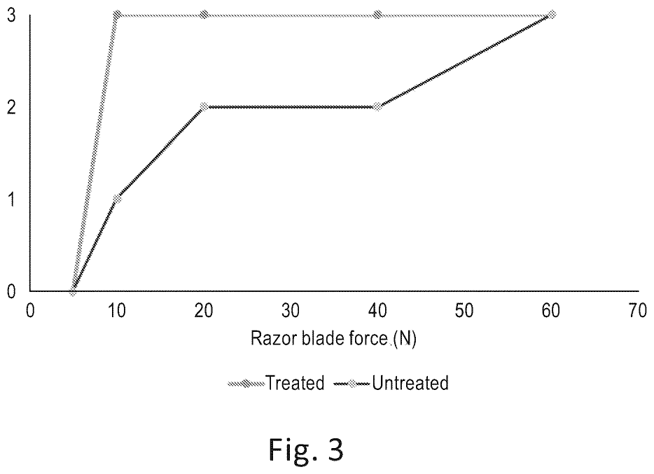

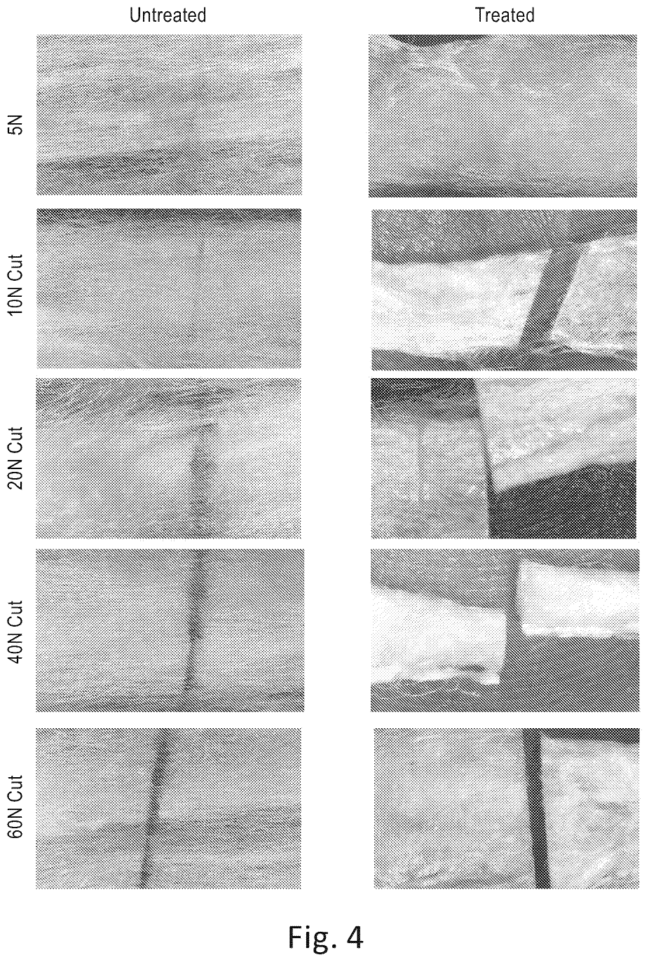

The ability to cut through a bundle of fibers was assessed with (treated) and without (untreated). A razor blade was clamped on the top clamp of an Instron 3345 tensiometer with a 100N load cell. Bundles of 20 mg on cut coupons were taped on a flat stainless-steel surface in place of the bottom clamp. The software was programmed to displace the top clamp in a compressive direction at a 20 mm/min rate until it reached the set force. Forces were set on different samples at (5, 10, 20, 40, 60) N and an image was taken of the cut zone. The graph in FIG. 3 and the images provided in FIG. 4 summarize 4 levels of results. 0—no cut, 1—partial cut seen but not enough to separate in two parts, 2—bundle separates but some fibers are still integral 3—cut separates bundle in two clear separate parts

1-44. (canceled)

45. A fiber composed of a material comprising or consisting regenerated cellulose covalently bonded to nanocellulose, wherein the fiber is used in a manufacture of a filtering device or a membrane capable of isolating or entrapping or arresting transfer of particulate materials from one end of the filter to the other.

46. The fiber according to claim 45, wherein the regenerated cellulose is provided as a fiber covalently associated with the nanocellulose.

47. The fiber according to claim 46, wherein the regenerated cellulose fiber is associated with one or more coats or layers of the nanocellulose.

48. The fiber according to claim 45, being a single or a multi-filament fiber.

49. The fiber according to claim 45, wherein the filtering device is a smoking article.

50. The fiber according to claim 45, wherein the filtering device is a cigarette tow.

51. The fiber according to claim 45, wherein the nanocellulose is selected from cellulose nanocrystals (CNC), nanofibrilar cellulose (NFC) and bacterial cellulose (BC).

52. The fiber according to claim 51, wherein the nanocellulose is CNC.

53. A bundle of fibers comprising at least one fiber according to claim 45.

54. The bundle of fibers according to claim 54, wherein the bundle consists fibers according to claim 45.

55. The bundle of fibers according to claim 53 in a form of a cigarette tow.

56. A cigarette tow comprising or consisting of a fiber composed of regenerated cellulose covalently bonded to nanocellulose.

57. The tow according to claim 56, provided wrapped in a plug wrap.

58. The tow according to claim 56, in a form joined via a tipping paper to a tobacco tow wrapped in a cigarette paper.

59. The tow according to claim 56, for use in a cigarette or an electronic cigarette.

60. A cigarette tow comprising a plurality of fibers composed of regenerated cellulose covalently associated with CNC.

61. A cigarette provided with a filter tow or an electronic cigarette adapted to receive a filter tow, wherein the filter tow is according to claim 56.

62. A kit or a commercial product containing a plurality of cigarette tows according to claim 56, rolling papers and tobacco, and optionally further instructions to roll a cigarette.

63. A method for producing a filter tow for a smoking article, the method comprising arranging a plurality of fibers composed of regenerated cellulose covalently bonded to nanocellulose into a rod structure with a first rod end, second filter rod end and a circumferential rod surface, wrapping the outer surface of the rod structure covering at least a part or a complete circumference of the rod surface; and optionally cutting the wrapped rod perpendicular to the rod longitudinal direction into rod segments, each segment being a filter tow suitable for the smoking article.

64. A method of manufacturing a smoking article, the method comprising joining a tobacco rod or a rod of a smoking material with a filter tow composed of fibers of regenerated cellulose covalently bonded to nanocellulose and connecting them with a tipping paper, and optionally cutting or shaping said joined tobacco rod and filter tow to provide the smoking article.
